(19) United States
(12) Patent Application Publication
(10) Pub. No.: US 2012/0055506 A1
(43) Pub. Date: Mar. 8, 2012

(54) SUBSTRATE CLEANING METHOD

(75) Inventors: Tsuyoshi Moriya, Tokyo (JP); Shin Yokoyama, Hiroshima (JP); Kikuo Okuyama, Hiroshima (JP)

(73) Assignee: TOKYO ELECTRON LIMITED, Minato-ku, Tokyo (JP)

(21) Appl. No.: 13/255,758

(22) PCT Filed: Mar. 10, 2010
(86) PCT No.: PCT/JP2010/054482

§ 371 Date: Nov. 18, 2011

(30) Foreign Application Priority Data
Mar. 12, 2009 (JP) 2009-059331

(51) Int. Cl. B08B 7/00

(52) U.S. Cl. 134/1

(57) ABSTRACT

In a substrate cleaning method for cleaning a substrate with fine patterns having grooves or holes whose representative length is 0.1 mm or less, the substrate is arranged in a space which contains water, such that the substrate faces an acute-angled leading end of a discharge electrode which can be cooled, with a predetermined interval therebetween, with a counter electrode being interposed at a predetermined position between the substrate and the discharge electrode. Then, a predetermined voltage is applied between the discharge electrode and the counter electrode while generating dew condensation in the discharge electrode by cooling the discharge electrode. The substrate is cleaned by generating an aerosol containing water particles having sizes of equal to less than 10 nm in the leading end of the discharge electrode and spraying the aerosol on the substrate.

### FIELD OF THE INVENTION

The present invention relates to a method of cleaning a substrate with a fine pattern formed thereon.

### BACKGROUND OF THE INVENTION

For example, a semiconductor device manufacturing process includes a cleaning process for removing foreign substances, by-products, unnecessary films (hereinafter referred to as “foreign substance and the like”) from a semiconductor substrate after performing processes such as an etching process, a film forming process and the like for the semiconductor substrate. In general, such a cleaning process includes a rinsing process for immersing a semiconductor substrate in a cleaning solution or spraying a cleaning solution on a semiconductor substrate while rotating the semiconductor substrate and then removing the cleaning solution and a drying process for removing a rinsing solution.

However, when a cleaning process using a cleaning solution (fluid) is performed for a semiconductor substrate with recent fine (thinned) resist patterns or etching patterns formed thereon, a so-called pattern collapse takes place due to a surface tension of the cleaning solution or a rinsing solution when the cleaning solution or the rinsing solution is removed from the semiconductor substrate.

To overcome such a problem, there has been proposed an aerosol cleaning method for cleaning an object by blowing an aerosol thereto to improve cleaning power without damaging fine patterns on the object, in which the aerosol collides with the object at a prescribed speed or higher, thereby locally generating a supercritical state or pseudo-supercritical state on the surface of the object (for example, see Patent Document 1).

In addition, there has been proposed an aerosol cleaning method for jetting an aerosol into a vacuum cleaning chamber from a nozzle in order to clean an object without damaging the micro structure of the object, in which an aerosol generating nozzle is insulated from heat, and an internal pressure thereof is set to be high so that the inside of the aerosol generating nozzle transits from a liquid-rich state into a gas-rich state, thereby reducing aerosol coagulation during adiabatic expansion when the aerosol is jetted from the nozzle (for example, see Patent Document 2).

Further, there has been proposed a substrate cleaning method in which, when a substrate accommodated in a chamber is cleaned by spraying gas containing an aerosol by using a Laval nozzle, a gas viscous flow is generated from evaporated gas or the like from the aerosol by adjusting the internal pressure of the chamber to several kPa to generate a descending flow inside the chamber and spraying aerosol-contained gas from the Laval nozzle (for example, see Patent Document 3).

Patent Document 1: Japanese Patent Application Publication No. 2003-209088

Patent Document 2: Japanese Patent Application Publication No. 2004-31924

Patent Document 3: Japanese Patent Application Publication No. 2006-147654

However, the aerosol cleaning method disclosed in Patent Document 1 has problems of apparatus becoming large-scale and complex and inflecting damages on fine patterns due to spraying of high speed aerosol on the substrate. In addition, the aerosol cleaning method disclosed in Patent Document 2 requires keeping the cleaning chamber vacuous. That is, since it takes a certain period of time for decrease/increase of pressure, it is difficult to increase a throughput. Further, the nano-aerosol cleaning method disclosed in Patent Document 3 aims at cleaning the rear surface of the substrate but does not define an effect of cleaning a surface with fine patterns formed thereon.

### SUMMARY OF THE INVENTION

In view of the above, the present invention provides a substrate cleaning method for cleaning a substrate with fine patterns formed thereon in a short time without having an adverse effect on the fine patterns.

In accordance with a first aspect of the present invention, there is provided a substrate cleaning method for cleaning a substrate with fine patterns formed thereon, wherein the fine patterns have grooves or holes whose representative length is equal to or less than 0.1 μm, the method including: a substrate arranging step of arranging the substrate in a space which contains water, such that the substrate faces an acute-angled leading end of a discharge electrode which can be cooled, with a predetermined interval therebetween, with a counter electrode being interposed at a predetermined position between the substrate and the discharge electrode; and a cleaning step of applying a predetermined voltage between the discharge electrode and the counter electrode while generating dew condensation in the discharge electrode by cooling the discharge electrode, wherein the cleaning step includes cleaning the substrate by generating an aerosol containing water particles having sizes of equal to or less than 10 nm in the leading end of the discharge electrode and spraying the aerosol on the substrate.

In this aspect, preferably, the counter electrode is an annular electrode whose portions are kept at an equal distance from the leading end of the discharge electrode.

In this aspect, preferably, the cleaning step includes applying a negative voltage to the discharge electrode and positively charging the substrate.

In this aspect, preferably, after the substrate arranging step and before the cleaning step, or in the cleaning step, the substrate is irradiated with a soft X-ray or light to ionize gas molecules in a processing atmosphere.

In accordance with a second aspect of the present invention, there is provided a substrate cleaning method for cleaning a substrate with fine patterns formed thereon, wherein the fine patterns have grooves or holes whose representative length is equal to or less than 0.1 μm, the method including: a substrate arranging step of arranging the substrate such that the substrate faces an acute-angled leading end of a hollow needle-like discharge electrode with a predetermined interval therebetween; and a cleaning step of applying a predetermined voltage between the discharge electrode and the substrate while supplying a cleaning solution to the discharge electrode, wherein the cleaning step includes cleaning the substrate by generating an aerosol of the cleaning solution having size of equal to or less than 10 nm in the leading end and spraying the aerosol on the substrate.

In this aspect, preferably, the cleaning solution is a sol which contains solid particles having sizes of equal to or less than 10 nm.

In this aspect, preferably, the solid particles are sprayed on the substrate by evaporating water from the aerosol until aerosol reaches the substrate.

In this aspect, preferably, after the substrate arranging step and before the cleaning step, or in the cleaning step, the substrate is irradiated with a soft X-ray or light to ionize gas molecules in a processing atmosphere.

### EFFECTS OF THE INVENTION

In accordance with the first aspect of the present invention, it is possible to remove foreign substance or the like from the substrate without causing a pattern collapse of the substrate with the fine patterns formed thereon.

Further, it is possible to perform a uniform cleaning process throughout the substrate by substantially uniformly diffusing the aerosol.

Further, it is possible to perform an efficient cleaning process with high cleaning power by accelerating particles contained in the aerosol toward the substrate.

Further, foreign substance attached to the substrate due to static electricity is neutralized by the generated ions to facilitate peeling them out of the substrate. Therefore, it is possible to perform a cleaning process with higher precision in a short period of time.

In accordance with the second aspect of the present invention, it is possible to remove foreign substance or the like from the substrate without causing a pattern collapse of the substrate with the fine patterns formed thereon.

Further, it is possible to obtain high cleaning power by both of liquid particles and solid particles cleaning effects.

Further, it is possible to clean the substrate with high cleaning power by solid particles.

Further, it is possible to perform a cleaning process with higher precision and in a short period of time since foreign substance attached to the substrate due to static electricity can be neutralized by the generated ions to facilitate peeling them out of the substrate.

### BRIEF DESCRIPTION OF THE DRAWINGS

FIG. 1 is a schematic plan view showing a structure of a substrate processing system to which a substrate cleaning method in accordance with the present invention is applied.

FIG. 2 is a schematic sectional view showing a configuration of a cleaning unit contained in the substrate processing system shown in FIG. 1.

FIG. 3 is a view showing a particle size distribution of nano-aerosols generated by the cleaning unit shown in FIG. 2.

FIG. 4 is a schematic plan view showing a structure of a different substrate processing system to which the substrate cleaning method in accordance with the present invention is applied.

FIG. 5 is a schematic sectional view showing a configuration of a cleaning unit contained in the substrate processing system shown in FIG. 4.

### DETAILED DESCRIPTION OF THE EMBODIMENT

Hereinafter, embodiments of the present invention will be described in detail with reference to the drawings. In the following description, a substrate cleaning method of this invention will be described by using a substrate processing system which performs an etching process on a semiconductor wafer (hereinafter abbreviated as “wafer”) as a substrate.

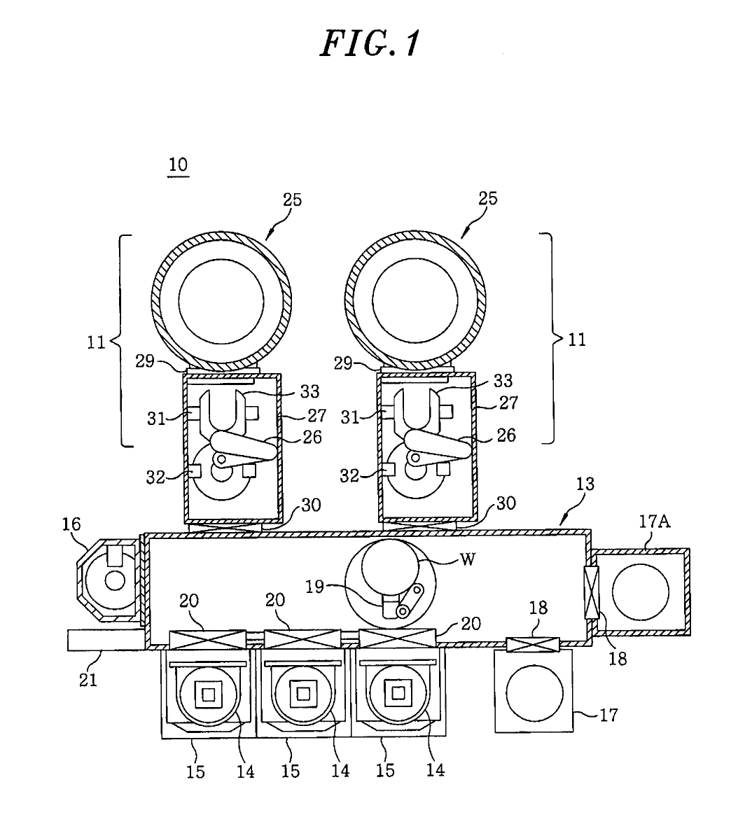

FIG. 1 is a schematic plan view showing a structure of a substrate processing system to which the substrate cleaning method in accordance with the present invention is applied. The substrate processing system 10 includes two process ships 11 each of which subjects a wafer W to a reactive ion etching (RIE) (anisotropic etching) process and an atmosphere transfer chamber (hereinafter referred to as a “loader module”) 13 as a common rectangular transfer chamber connected with these process ships 11.

The loader module 13 is connected with three FOUP loaders 15 loading respective FOUPs 14 as containers each for accommodating, for example, 25 wafers W, an orienter 16 for pre-aligning positions of wafers W carried out of the FOUPs 14, a cleaning unit 17A for cleaning wafers W subjected to an RIE process, and a wafer reversing unit 12 for reversing the front surface/rear surface of a wafer W.

The two process ships 11 are arranged to face the three FOUP loaders 15 with the loader module 13 interposed therebetween while being connected to a longitudinal side wall of the loader module 13. The wafer reversing unit 12 is arranged in parallel to the FOUP loaders 15. The orienter 16 is arranged in one longitudinal end of the loader module 13 and the cleaning unit 17A is arranged in the other longitudinal end of the loader module 13.

As will be described in detail later, a cleaning process is performed in the cleaning unit 17A with the front surface (surface with fine patterns) of the wafer W directing downward. The wafer reversing unit 12 reverses the wafer W in order to carry the wafer W into the cleaning unit 17A and return wafers W cleaned in the cleaning unit 17A to the FOUPs 14.

Within the loader module 13 is arranged a scalar-typed dual arm type transfer arm mechanism 19 for transferring wafers W. On the side wall of the loader module 13 which faces the FOUP loader 15 are provided three load ports 20 used as slots or FOUP connection ports for loading/unloading the wafers W at positions corresponding to the positions of the FOUP loaders 15. Similarly, load ports 18 are provided on the side walls of the loader module 13 at positions corresponding to positions of the wafer reversing unit 12 and the cleaning unit 17A.

With the above configuration, the transfer arm mechanism 19 takes the wafers W out of the FOUPs 14 loaded on the FOUP loaders 15 via the load ports 20 and carries the taken wafers W in/out of the process ships 11, the orienter 16, the wafer reversing unit 12 and the cleaning unit 17A.

Each process ship 11 includes a process module 25 as a vacuum processing chamber for subjecting the wafers W to the RIE process, and a load-lock module 27 containing a link-typed signal pick type transfer arm 26 for exchanging the wafers W with the process module 25.

Although not shown in detail, the process module 25 includes a cylindrical chamber for accommodating the wafers W, a wafer stage which is arranged within the chamber for loading the wafers W, and an upper electrode arranged to face the top of the wafer stage with a predetermined gap therebetween. The wafer stage has a function of chucking the wafers W by virtue of a Coulomb force and also a lower electrode function and a gap between the upper electrode and the wafer stage is set to be a distance appropriate for subjecting the wafers W to the RIE process.

In the process module 25, process gas such as fluorine-based gas or bromine-based gas is introduced into the chamber and is plasmarized by applying an electric field between the upper electrode and the lower electrode to generate ions and radicals, and then the wafers W are subjected to the RIE process using the generated ions and radicals. For example, a polysilicon layer formed on a surface of a wafer W is etched to form a fine pattern.

In each process ship 11, the internal pressure of the process module 25 is kept vacuous, whereas the internal pressure of the loader module 13 is kept atmosphere environment. Accordingly, by providing a vacuum gate valve 29 in a connector to the process module 25 while providing an atmosphere gate valve 30 in a connector to the loader module 13, the internal pressure of the load-lock module 27 can be adjusted between the vacuum environment and the atmosphere environment.

In each load-lock module 27, the transfer arm 26 is provided substantially in the middle thereof and first and second buffers 31 and 32 are provided in sides close to the process module 25 and the loader module 13, respectively. The first and second buffers 31 and 32 are arranged on a track along which a pick 33 for supporting a wafer W loaded on the leading end of the transfer arm 26 moves. By temporarily shunting a wafer W subjected to the RIE process above the trace of the pick 33, a smooth switching in the process module 25 between a wafer W not yet subjected to the RIE process and a wafer W already subjected to the RIE process becomes possible.

In the substrate processing system 10, an operation controller 40 for controlling operation of the process ship 11, the loader module 13, the orienter 16 and the cleaning unit 17A is arranged in the one longitudinal end of the loader module 13. That is, the operation controller 40 executes a program related to performing the RIE process, the cleaning process and the wafer W transferring process based on predetermined recipes. Thus, operation of various working components included in the substrate processing system 10 is controlled. In addition, the operation controller 40 has a display unit (not shown) such as a liquid crystal display (LCD) or the like to allow an operator to check recipes and operation situations of various working components.

In the above-configured substrate processing system, when the FOUPs 14 accommodating wafers W are loaded in the FOUP loaders 15, the load ports 20 are opened, the wafers W are taken out of the FOUPs 14 by means of the transfer arm mechanism 19, and the wafers W are loaded into the orienter 16. The wafers W subjected to positional alignment in the orienter 16 are taken out of the orienter 16 by means of the transfer arm mechanism 19 and are transferred to the transfer arm 26 within the load-lock module 27 kept in the atmosphere environment via the atmosphere gate valve 30 of one process ship 11.

After the atmosphere gate valve 30 is closed and the load-lock module 27 is placed under the vacuum environment, the vacuum gate valve 29 is opened to carry the wafer W into the process module 25. After the vacuum gate valve 29 is closed and the RIE process is performed in the process module 25, the vacuum gate valve 29 is again opened and the wafer W is carried out of the process module 25 by means of the transfer arm 26 within the load-lock module 27.

After the vacuum gate valve 29 is again closed, the load-lock module 27 returns to the atmosphere environment and the atmosphere gate valve 30 is opened to allow the transfer arm 26 to transfer the wafer W to the transfer arm mechanism 19. The transfer arm mechanism 19 carries the wafer W through the load port 18 into the wafer reversing unit 12 where the wafer W is reversed. The transfer arm mechanism 19 takes the wafer W out of the wafer reversing unit 12 and carries it into the cleaning unit 17A where the wafer W is cleaned. Details of this cleaning will be described in detail later. The transfer arm mechanism 19 takes the cleaned wafer W out of the cleaning unit 17A, carries it into the wafer reversing unit 12 where it is reversed, takes it out of the wafer reversing unit 12, and accommodates it in the FOUPs 14.

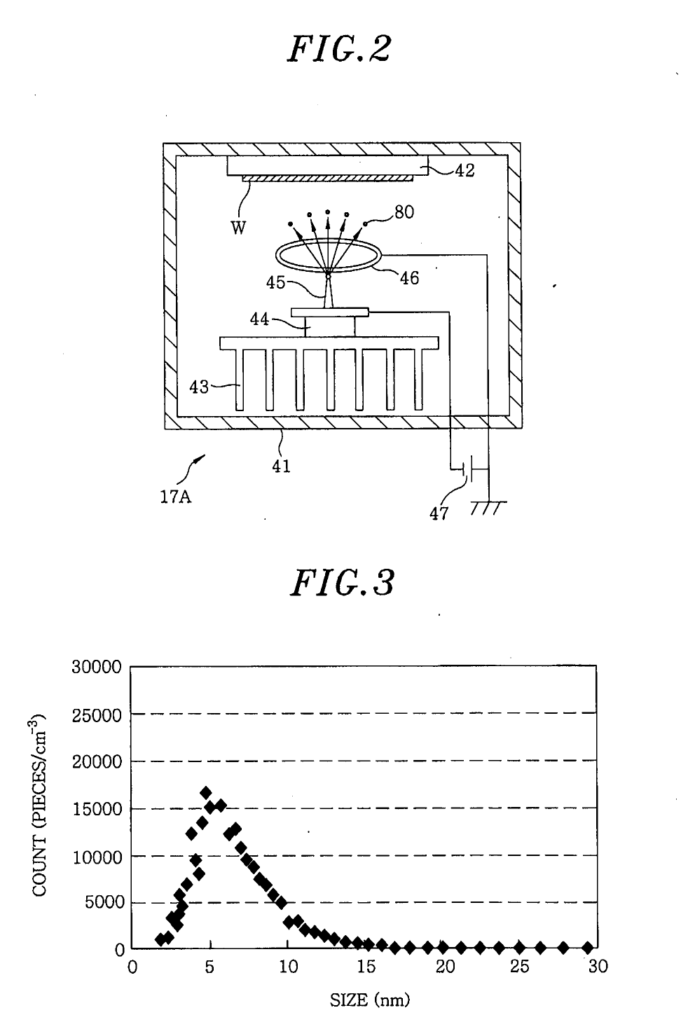

Next, the cleaning unit 17A will be described in detail. FIG. 2 is a schematic sectional view showing a configuration of the cleaning unit shown in FIG. 1. The cleaning unit 17A includes a chamber 41 defining a space where a predetermined amount of water (vapor) is contained, a holding member 42 placed within the chamber 41 for holding a wafer W, and a nano-aerosol generator for spraying nano-aerosols containing water particles 80 on the wafer W held by the holding member 42.

Within the chamber 41 is arranged a humidity sensor used to keep the chamber 41 at a constant humidity, and vapor is fed into the chamber 41 in order to keep a humidity detected by the humidity sensor at a predetermined value.

As used herein, the term “nano-aerosol” refers to nano-sized liquid particles and/or solid particles in gas. The nano-aerosol generator includes a discharge electrode 45 having an acute-angled leading end, a cooling mechanism 44 for cooling the discharge electrode 45, radiation fins 43 for supporting the cooling mechanism 44 and dissipating heat generated while the cooling mechanism 44 is cooling the discharge electrode 45, and a counter electrode 46 which is separated by a predetermined distance from the leading end of the discharge electrode 45. A constant voltage is applied from a DC power supply 47 to the discharge electrode 45 and the counter electrode 46.

The wafer W is held by the holding member 42 in such a manner that the surface of the wafer W directs downward and faces the leading end of the discharge electrode 45 at a predetermined distance with the counter electrode 46 interposed therebetween. Preferably, the holding member 42 has an electrode serving to positively charge the wafer W.

The leading end of the discharge electrode 45 has, for example, substantially a conical shape. In this case, assuming an apex angle (vertex angle) of the leading end is θ, 2θ exhibits an acute angle (i.e., 2θ<90°). The cooling mechanism 44 may employ an element such as a Peltier element or the like. Although FIG. 2 shows that the radiation fins 43 are arranged within the chamber 41, a plurality of fins for effectively dissipating heat may be arranged outside the chamber 41 while arranging a part holding the cooling mechanism 44 within the chamber 41.

As shown in FIG. 2, it is preferable that an annular electrode is used as the counter electrode 46 and its portions are kept at an equal distance from the leading end of the discharge electrode 45 (i.e., the leading end of the discharge electrode 45 is located on the center axis of the ring). This facilitates regular conical spraying of the water particles 80 from the leading end of the discharge electrode 45 and uniform impact of the water particles 80 on the wafer W.

The nano-aerosol generator generates aerosols containing the water particles 80 as follows. Since a certain quantity of vapor exists in the chamber 41, the cooling mechanism 44 cools the discharge electrode 45 to a temperature at which dew condensation occurs in the discharge electrode 45. That is, an atmosphere within the chamber 41 is a source of supply of water to the discharge electrode 45. If a voltage is applied in such a manner that the discharge electrode 45 has a negative electric potential and the counter electrode 46 has a ground potential, for example, a potential difference of about 5 kV is produced between the discharge electrode 45 and the counter electrode 46, water condensed with dew on the discharge electrode 45 rises to the leading end of the discharge electrode 45 where the water is decomposed into particles to be ejected toward the counter electrode 46 (electrostatic spraying). Then, by positively charging the wafer W, the water particles 80 are accelerated to impact on the surface of the wafer W. Thus, the surface of the wafer W is cleaned by the water particles 80.

FIG. 3 is a measure of dispersion (graph) showing a result of measurement of particle size distribution of nano-aerosols generated by the nano-aerosol generator shown in FIG. 2, which is measured by using a condensation nucleation counter (CNC) method. It can be seen from the graph of FIG. 3 that water particles 80 having size of equal to or less than 10 nm can be efficiently generated, which results in high cleaning capability.

Next, a flow of process of a wafer W in the cleaning unit 17A will be described. The cleaning unit 17A takes as a main processing object a wafer W with fine patterns having grooves or holes whose representative length is equal to or less than 0.1 μm. This is because a semiconductor wafer with fine patterns having grooves or holes whose representative length exceeds 0.1 μm may employ a cleaning process using immersion of the wafer in a conventional cleaning solution.

First, the wafer W whose surface directs downward is carried in the chamber 41 and is held by the holding member (substrate arranging step). Next, while cooling the discharge electrode 45 to generate dew condensation in the discharge electrode 45, a certain voltage is applied between the discharge electrode 45 and the counter electrode 46 to generate an aerosol containing water particles 80 having sizes of equal to or less than 10 nm in the leading end of the discharge electrode 45 and the generated aerosol is sprayed on the wafer W (cleaning step).

In the cleaning step, the water particles 80 impinge to impact on concave portions of the fine patterns, such as grooves or holes, thereby allowing foreign substance and the like to be removed from the concave portions. In the cleaning step, by positively charging the wafer W, the water particles 80 can be accelerated toward the wafer W, thereby increasing cleaning power and cleaning efficiency.

In addition, in the cleaning step, temperature of the wafer W, humidity near the surface of the wafer W and the amount of spray of the water particles 80 are determined to promptly dry the surface of the wafer W without forming any water curtain.

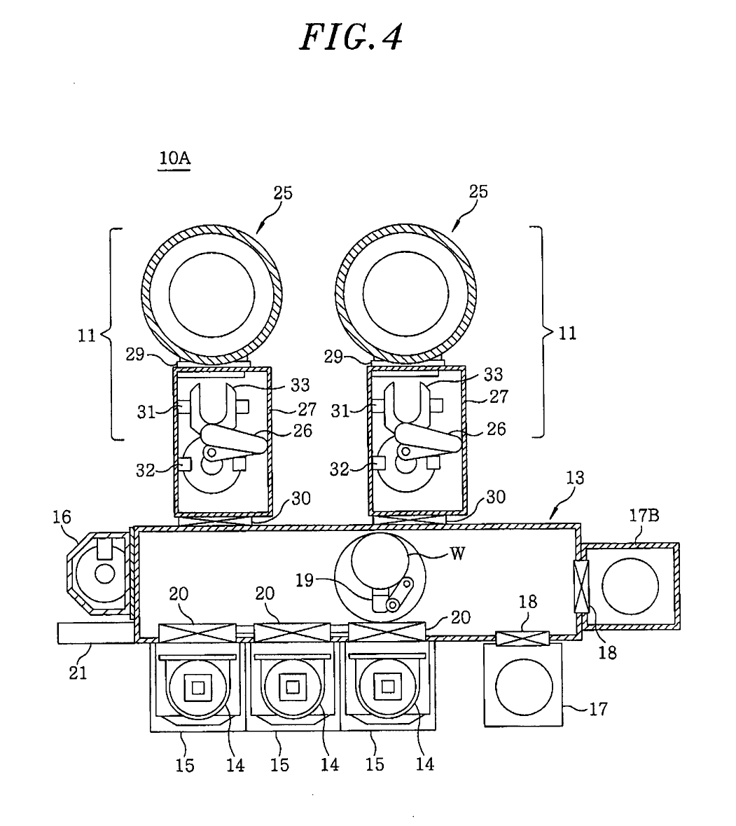

Next, another embodiment of the present invention will be described. FIG. 4 is a schematic plan view showing a structure of a second substrate processing system to which the substrate cleaning method in accordance with the present invention is applied.

This substrate processing system 10A is different from the substrate processing system 10 shown in FIG. 1 in that a cleaning unit 17B is replaced for the cleaning unit 17A and has no need to reverse the wafer W since a cleaning process is performed with the front surface of the wafer W directing upward and its rear surface directing downward, as will be described later, thereby requiring no wafer reversing unit 12. Therefore, only the cleaning unit 17B will be described in detail below.

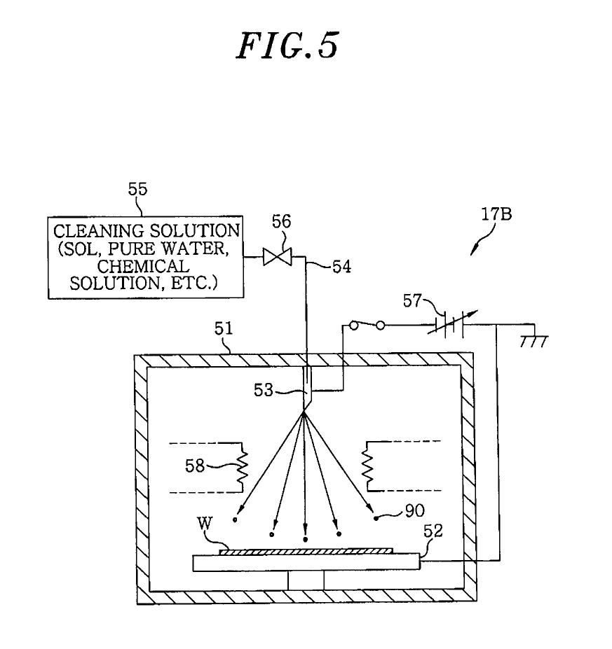

FIG. 5 is a schematic sectional view showing a configuration of the cleaning unit shown in FIG. 4. The cleaning unit 17B includes a chamber 51 for accommodating a wafer W, a stage 52 placed within the chamber 51 for loading the wafer W thereon, a hollow needle-like syringe nozzle 53 placed within the chamber 51 and located above the stage 52, and a heater 58 (heating mechanism) interposed between the stage 52 and the syringe nozzle 53 for heating an aerosol sprayed from the syringe nozzle 53.

A predetermined voltage is applied by a DC power supply 57 between the stage 52 and the syringe nozzle 53. In addition, the syringe nozzle 53 is connected with a cleaning solution feeding line 54 for feeding a cleaning solution from a cleaning solution source 55 and feed/stop of the cleaning solution is controlled by opening/closing a valve 56.

In the cleaning solution source 55, one appropriate for a cleaning solution may be selected from pure water, chemical solution, sol containing solid particles, and the like. Examples of solid particles may include Si, SiO₂, Al, Al₂O₃, Y, Y₂O₃, C—F polymer and so on and their sizes are equal to or less than 10 nm, preferably, equal to or less than 5 nm.

In the cleaning unit 17B configured above, when a certain amount of cleaning solution is supplied to the syringe nozzle 53 under the state where the predetermined voltage is applied between the syringe nozzle 53 and the stage 52, nano-aerosols containing cleaning solution particles 90 having sizes of equal to or less than 10 nm as main ingredients can be generated through the same mechanism as the mechanism (electrostatic spraying) to generate water particles in the cleaning unit 17A and can be sprayed toward the surface of the wafer W from the leading end of the syringe nozzle 53. In this case, the sizes of the cleaning solution particles 90 can be controlled by the voltage applied by the DC power supply 57.

Although the cleaning unit 17B uses the stage 52 as a counter electrode against the syringe nozzle 53 acting as a discharge electrode, a counter electrode may be provided between the syringe nozzle 53 and the wafer W, similarly to the cleaning unit 17A, and the stage 52 can be equipped with a function to charge the wafer W so that the generated nano-aerosols can be accelerated toward the wafer W.

If a certain amount of sols is supplied to the syringe nozzle 53, particles including only solvent ingredients of the sols and particles including solid particles and solvent ingredients can be generated and sprayed toward the surface of the wafer W from the leading end of the syringe nozzle 53. Impacting not only the particles including the solvent ingredients of the sols but also the solid particles on the surface of the wafer W can improve cleaning power.

At this time, only solid particles can be generated by heating the generated particles by means of the heater 58 to evaporate the solvent ingredients. Thus, preferably, only the solid particles are impacted on the wafer W to be cleaned, thereby achieving high cleaning power.

In addition, by making the solid particles produced have sizes of equal to or less than 10 nm as mentioned above, the momentums of the solid particles are reduced so that their impacts on the wafer W are reduced when they collide with the wafer, thereby making it possible to remove particles attached to fine patterns on the surface of the wafer W without damaging the fine patterns.

Next, modifications of the cleaning units 17A and 17B will be described. The cleaning unit 17A may be modified to have a structure where the discharge electrode 45 is a thinned needle-like electrode and is not cooled, and the cleaning unit 17B may be modified to have a structure where the syringe nozzle 53 is supplied with no cleaning solution or sol and is changed to a thinned needle-like electrode. In these modifications, by taking the needle-like electrode as the discharge electrode and applying a predetermined voltage between the discharge electrode and a counter electrode (the counter electrode 46 for the cleaning unit 17A, or the stage 52 for the cleaning unit 17B), it is possible to clean the surface of the wafer W by atomizing material of the needle-like electrode into solid particles and impacting the solid particles on the wafer W. In order to generate a majority of solid particles having sizes of equal to or less than 10 nm, it is preferable that a magnitude of voltage applied between both electrodes is adjusted based on material of the needle-like electrode.

When the above-described cleaning method using the solid particles (including using the sols for the cleaning unit 17B) is employed, the solid particles can be removed from the wafer W by, for example, cooling the rear surface of the wafer W while heating the front surface of the wafer W. In this case, depressurizing the chamber 41 or 51 to several tens Torr or so can increase its effects.

In addition, it is preferable to irradiate the surface of the wafer W with a soft X-ray before or during performance of the cleaning process using the above-described liquid particles and solid particles. This is because adhesion of solid foreign substance such as particles to fine patterns is mainly attributable to static electricity and accordingly the solid foreign substance can be easily removed (peeled off) by the liquid particles and the solid particles by neutralizing such static electricity. Specifically, a weak soft X-ray is used to decompose molecules in the atmosphere and generate ions. This allows the solid foreign substance to be neutralized with the generated ions in a region irradiated with the soft X-ray. In this case, since ions can be generated near the solid foreign substance, such neutralization is possible. Alternatively, a light irradiation type neutralizer may be replaced for the soft X-ray, in which case the light irradiation type neutralizer is effective for neutralization of fine patterns since a neutralization effect can be achieved only with the light irradiation.

The present invention is not limited to the disclosed embodiments. For example, although the substrate processing system having the process module 25 for subjecting the wafer W to the RIE process has been illustrated in the above, the process module may be used to subject the wafer W to a film forming process or a diffusion process.

In the disclosed embodiments, the substrate processing system 10 was constructed by connecting the cleaning unit 17A to an RIE processing apparatus. In this manner, the cleaning unit 17A can easily be connected and applied to various conventional processing apparatuses such as for RIE, film formation, diffusion processes and so on; on the other hand, the cleaning unit 17A may be used as a separate unit without being connected to these apparatus.

Although a substrate has been illustrated with a semiconductor wafer in the above description, the substrate is not limited thereto but may be other types of substrates such as a substrate for FPD (Flat Panel Display) such as LCD (Liquid Crystal Display), a photo mask, a CD substrate, a print substrate and so on.

The object of the present invention is achieved by the operation controller 40 where a storage medium recorded therein with program codes of software to implement the functionalities of the disclosed embodiments is provided in a computer (for example, a control unit) and a CPU of the computer reads and executes the program codes stored in the storage medium.

In that case, the program codes themselves read out of the storage medium implement the functionalities of the disclosed embodiments and the program codes and the storage medium storing the program codes are included in the present invention.

Examples of the storage medium to provide the program codes may include RAM, NV-RAM, Floppy® disk, hard disk, magneto-optical disk, optical disk such as CD-ROM, CD-R, CD-RW and DVD (DVD-ROM, DVD-RAM, DVD-RW, DVD+RW), magnetic tape, nonvolatile memory card, or other ROMs which can store the program codes. Alternatively, the program codes may be provided to the computer by downloading them from other computers or databases (not shown) connected to the Internet, commercial networks, local area networks and so on.

In addition, the functionalities of the disclosed embodiments can be implemented not only by executing the program codes read by the computer but also by executing some or all of actual processes by means of an OS (Operating System) or the like running on the CPU based on instructions of the program codes.

Furthermore, after the program codes read from the storage medium are stored in a memory provided in a functional extension board inserted in the computer or a functional extension unit connected to the computer, the functionalities of the disclosed embodiments can be implemented by executing some or all of actual processes by means of a CPU provided in the functional extension board or the functional extension unit based on instructions of the program codes.

Types of the program codes may include object codes, program codes executed by an interpreter, script data supplied to an OS, and the like.

What is claimed is:

1. A substrate cleaning method for cleaning a substrate with fine patterns formed thereon, wherein the fine patterns have grooves or holes whose representative length is equal to or less than 0.1 μm, the method comprising:
a substrate arranging step of arranging the substrate in a space which contains water, such that the substrate faces an acute-angled leading end of a discharge electrode which can be cooled, with a predetermined interval therebetween, with a counter electrode being interposed at a predetermined position between the substrate and the discharge electrode; and
a cleaning step of applying a predetermined voltage between the discharge electrode and the counter electrode while generating dew condensation in the discharge electrode by cooling the discharge electrode,
wherein the cleaning step includes cleaning the substrate by generating an aerosol containing water particles having sizes of equal to or less than 10 nm in the leading end of the discharge electrode and spraying the aerosol on the substrate.

2. The substrate cleaning method of claim 1, wherein the counter electrode is an annular electrode whose portions are kept at an equal distance from the leading end of the discharge electrode.

3. The substrate cleaning method of claim 1, wherein the cleaning step includes applying a negative voltage to the discharge electrode and positively charging the substrate.

4. A substrate cleaning method for cleaning a substrate with fine patterns formed thereon, wherein the fine patterns have grooves or holes whose representative length is equal to or less than 0.1 μm, the method comprising:
a substrate arranging step of arranging the substrate such that the substrate faces an acute-angled leading end of a hollow needle-like discharge electrode with a predetermined interval therebetween; and
a cleaning step of applying a predetermined voltage between the discharge electrode and the substrate while supplying a cleaning solution to the discharge electrode,
wherein the cleaning step includes cleaning the substrate by generating an aerosol of the cleaning solution having sizes of equal to or less than 10 nm in the leading end and spraying the aerosol on the substrate.

5. The substrate cleaning method of claim 4, wherein the cleaning solution is a sol which contains solid particles having sizes of equal to or less than 10 nm.

6. The substrate cleaning method of claim 4, wherein the solid particles are sprayed on the substrate by evaporating water from the aerosol until aerosol reaches the substrate.

7. The substrate cleaning method of claim 1, wherein, after the substrate arranging step and before the cleaning step, or in the cleaning step, the substrate is irradiated with a soft X-ray or light to ionize gas molecules in a processing atmosphere.
